(19) United States
(12) Patent Application Publication
(10) Pub. No.: US 2006/0169152 A1
(43) Pub. Date: Aug. 3, 2006

(54) Reamer structure of a juicer

(76) Inventors: Kou-I Lin, San-Chung (TW); Rong-Yuan Tseng, Tam-Sui (TW)

Correspondence Address: Lin, Kou-I, P.O. Box 166-13, Taipei, 115, TW

(21) Appl. No.: 11/044,913

(22) Filed: Jan. 28, 2005

(51) Int. Cl. A47J 43/14

(52) U.S. Cl. 99/495

(57) ABSTRACT

The objective of the present invention is to provide a reamer structure of a juicer, a mask added to fit over the reamer, make the cut-halves or not cut halves to extract and seep out the juice sooner and better. To achieve the objective, the present invention has a truncated apex opening surrounded by the cutting edges formed on the top end of the reamer, and the base member formed integrally at the bottom end bulged out lateral scrapers projected up close to the surface of straining tray, a larger mask fits over the reamer to expand the size of the reamer, the bottom end of the mask has an annular tough with apertures adapted to the scrapers, combine the reamer and the mask to form a double deck reamer.

### FIELD OF THE INVENTION

The present invention is related to a reamer structure of a juicer, more particularly to a half-automatic juicer or a hand-operated juicer for more fruit juice extraction efficiently.

### BACKGROUND OF THE INVENTION

Juicer of the prior art has a driving mechanism, comprising an electric motor and a gear set, for driving a reamer to rotate, on which a plurality of claw shaped projections squeezing the fruit flesh for juice extraction. And the user of hand-operated juicer exerts pressure with his palm continuously pressing downward the cut halves fruits on the reamer to extract the juice. The hemispheric reamer has an apex as the claw shaped projections of the juicing cone meet and a plurality of claw shaped projections surface to grate the pulp. The extracted juice flows in the radial direction on the reamer and a significant amount of juice is collected within a container under the reamer.

Because of the necessity of fruit cutting, the conventional juice extraction process is dangerous for a child to operate, and spilt fruit juice soils the kitchen utensils. Further, the use of a knife and a cutting board brings extra cleaning work.

A defect of the juicers of the prior art is that a half citrus fruit is easy to get slipped on a reamer having a plurality of claw shaped projections. A citrus fruit usually has a firm core axis, which is where the fruit flesh converges. After the citrus fruit is cut perpendicularly across the core axis into two halves, pulp segments extend in a radial direction from the core axis. Since the firm core axis is pressed against the apex of the juicing cone when a half citrus fruit is engaged with the reamer for juice extraction, the core axis is easy to slip off the apex, causing a misalignment of the half citrus fruit with the reamer, a user's palm or fingers may touch the apex, projections instead.

The structure of the reamer having claw shaped projections, which has an arcuate conic surface and a converged apex, as a half fruit is pressed against the reamer the firm core axis and the radial fibers link between the pulp segments resist against the apex and the claw like projections as a whole, a half of the citrus fruit is easy to slip off the apex and becomes misaligned with the reamer.

Point exactly against the aforesaid defects, the inventor applied in U.S. patent before USPTO for an invention entitled “reamer structure of the juicer” and assigned the application number as Ser. No. 11/006,227 on 7 Dec. 2004, it has also been earlier published on 21 Apr. 2005, the characteristics of the prior art comprising: an opening formed on a top portion of said reamer having a sharp cutting edge for engaging a fruit, said cutting edge being further provided with a plurality of annularly arranged teeth;

Juicers of the prior art are suitable for the fruits such as citrus applied to extracting juice from onto the reamer, but the large edible fruit has to anchor one's fingers exerting pressure onto the center of the fruit to squeeze, for a longer duration of manual operation, the user will have a sore arm. In case of the present invention the reamer could be expanded as desired, the user might operate by pressing downward with one's palm only. And there is no need to anchor one's fingers to exert pressure excessively, thus relieve the boredom of extraction.

### SUMMARY OF THE INVENTION

Accordingly, the objective of the present invention is to provide a reamer structure of a juicer to improve the aforesaid defects, it can reduce the labor cost, and get a significant amount of strained juice, in that, instead of the pre-process of the cut-halves for juicing, an easy way of the present invention is provided as following:
6. Unpeeled fruits can be applied to squeeze and extract the juice from the pulp, even exempted from cutting fruits into halves.
7. The reamer and the mask combined to form a safe kitchen utensil for the children to use, a circular shaped cutting edge even for unpeeled fruits to extract juice, a mask covered the squeezed fruit, and the fruit covered the cutting edge. It is safe in consideration of children's trial and error learning about household kitchen utensils.
8. The core portion of the unpeeled fruits can be separated from the pulp by an upper opening inscribed within the cutting edge. The unpeeled fruit is applied to extract juice from the pulp portion of the fruit only.
9. Thus save the extra clean work of washing the knife and cutting board after juice extraction.
10. The core portion of the fruits has saturated fibers, which can be fiber-linked with the pulp, after the extraction of juice, the squeezed pulp and the core portion will be drawn out together.

Therefore, the present invention provides a reamer (5) structure of a juicer (10) comprising: the reamer (5) is a bell-shaped tube; the reamer has an opening (51) formed on the truncated apex (51) and a plurality of claw shaped projections (55) extended downward from said opening (51) and distributed equidistantly along central axis of said reamer (5); said reamer (5) having a sharp cutting edge (51) around said opening (51) for engaging a fruit, said cutting edge (51) being further provided with a plurality of annularly arranged teeth (52); and a base member (53) integrally formed on the bottom end of said reamer (5), said base member (53) having a polygonal locking receptacle (54) projected centrally downward inside its bottom thereby secured to an upstanding spindle (12) extended from a driving unit (11) of said juicer (10); scrapers (56) bulged out from along the flanged rim of the base member (53); wherein a mask (7) fits over the reamer (5); said mask (7) is surrounded by an annular trough (74) with apertures along its base (73) annular rim for adapting to the scrapers bulged out from the base member (53) of the reamer (5); said mask (7) having a truncated top opening cutting edge (71); said mask (7) has a plurality of claw shaped projections (75) extended downward from the truncated top opening (71).

Moreover, the present invention has achieved the merits as following:

To extract the juice from the unpeeled fruits can be performed by the reamer alone, or with the mask added to form a double deck reamer so as to expand the reamer, which is suitable for the large edible fruit to grate. The mask even has a truncated top opening cutting edge for engaging the fruit, a plurality of claw shaped projections surface is easy to rub against the pulp of the fruits.

A plurality of annularly arranged teeth set along the ridge of the truncated top opening cutting edge is convenient for penetrating into the unpeeled fruits.

### BRIEF DESCRIPTION OF THE DRAWINGS

FIG. 1 is an exploded perspective view of the first preferred embodiment half automatic juicer of the present invention.

FIG. 2 is a perspective view of the first embodiment of the present invention.

FIG. 3 is an assembly view of the first embodiment of the present invention.

FIG. 4 is a diagram view of the first embodiment as the half-automatic juicer extracting juice from the fruits.

FIG. 5 is a whole cross section view of the first embodiment of the present invention.

FIG. 6A is a diagram view of the first embodiment before peeling the fruits.

FIG. 6B is a diagram view of the first embodiment after peeling the fruits.

FIG. 7 is a diagram view of the assembly of the double deck reamer of the second embodiment

FIG. 8 is a diagram view of squeezing juice in accordance with the second embodiment double deck reamer of the present invention.

FIG. 9 is an exploded perspective view of the hand-operated juicer of the third embodiment of the present invention.

FIG. 10 is a perspective view of the reamer of the third embodiment of the present invention.

FIG. 11 is a diagram view for squeezing juice by the half automatic juicer of the third embodiment of the present invention.

FIG. 12 is a whole cross section view of the half automatic juicer of the third embodiment of the present invention.

### GLOSSARY

Seat (1)
Waterproof nut (2)
Gathering tray (3)
Straining tray (4)
Reamer (5)
Cap (mask) (6)
Mask (7)
Unpeeled fruit, Cut halves (8)
Juicer (10)
Driving device (11)
Driving shaft (12)
Positioning spindle (14)
Hollowed central bore (31)
Dispel tube (32)
Central opening (41)
Straining silt (42)
Cutting edge (51)
Annular teeth (52)
Pedestal (61)
Base member (53)
Polygonal locking receptacle (54)
Vertical claw like projections (55)
Scraper (56)
L shape handle (62)
Truncated top opening (71)
Teeth (72)
Base member (73)
Annular trough (74)
Vertical claw shaped projections (75)
Juice (81)
Dreg (82)
Peel (83)
Core portion (85)
Circular incisure (87)

### DETAILED DESCRIPTION OF THE PREFERRED EMBODIMENTS

The description is described according to the appended drawings hereinafter:

### The First Embodiment

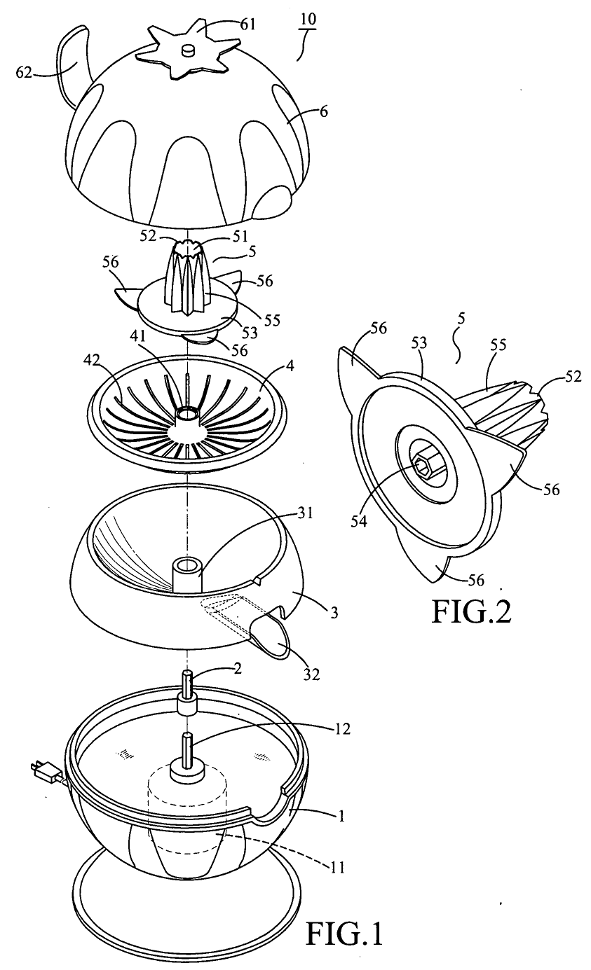

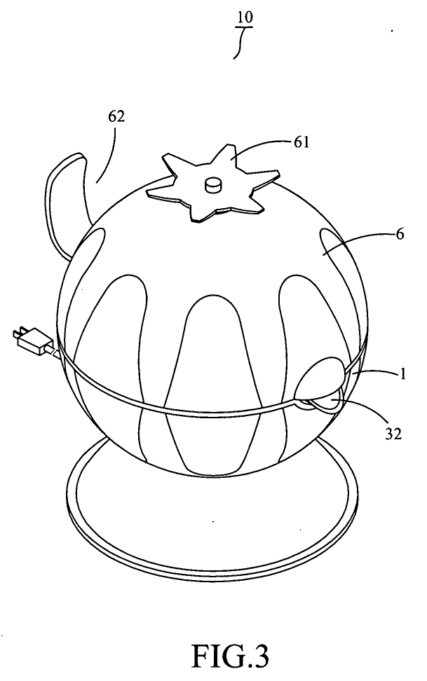

Referring to FIG. 1, an exploded perspective view of the first embodiment is illustrated. A half-automatic juicer (10) includes a driving device (11), and a driving shaft (12); a waterproof nut (2) fits over the top end of the driving shaft (12), a gathering tray (3) is located above the seat (1), a straining tray (4) is superimposed and added together in a “bipack” arrangement with the gathering tray (3) placed beneath, a reamer (5) fits over the top end of the waterproof nut (2) by a polygonal locking receptacle (54) (as FIG. 2 is illustrated), and a cap (mask) 6 has a plurality of claw shaped projections formed on its top surface as an inverted pedestal (61), the cap (mask) (6) also has an L shape handle (62) on its lateral side; thus the mentioned-above components combined to form a juicer (10). The mentioned-above components contribute to the semblance of the juicer is illustrated as shown in FIG. 3. Said reamer (5) is a bell-shaped tube, flares slightly downward which is broad at the lower end. Said reamer (5) having a truncated apex opening cutting edge (51) for engaging a fruit, said cutting edge (51) being further provided with a plurality of annularly arranged teeth (52).

Under loading condition, an occupant weight sensor embedded inside the driving device (11) may respond to the outside pressure and make the motor to rotate. Conversely, while eliminating the outside pressure, the motor will stop to rotate. Above-mentioned is a loading-mode control of the conventional gear set to control. There is no need to discuss much about the structure and techniques of the conventional motor and gear set. But the driving device (11) makes the driving shaft (12) to rotate, simultaneously causes the waterproof nut (2) and reamer (5) to rotate. The waterproof nut (2) passes through the hollowed central bore (31) of the gathering tray (3) combined to the reamer (5). And the straining tray (4) is placed above the gathering tray (3). The central opening (41) of the straining tray (4) made to fit and match equally with the corresponding central bore (31) of the gathering tray (3).

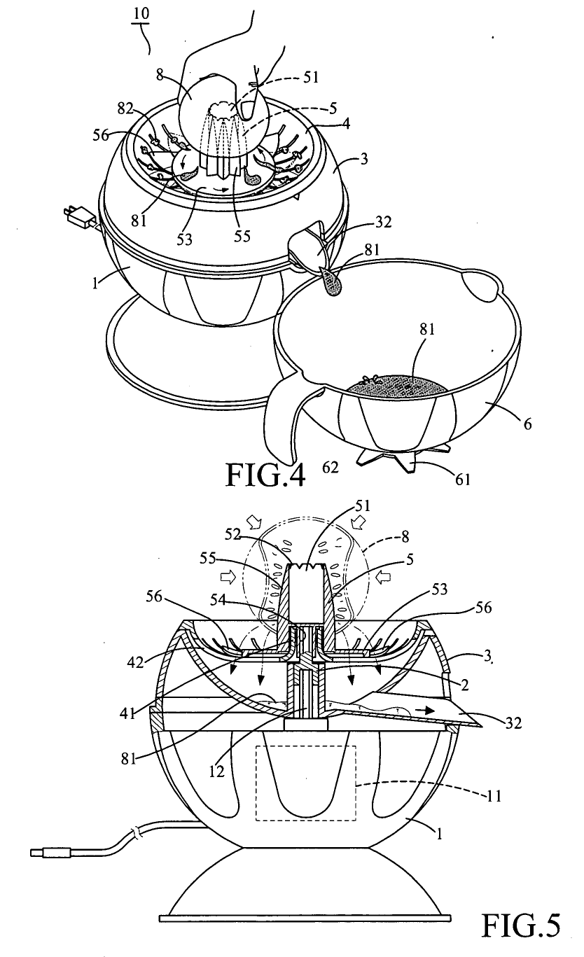

Referring to FIG. 4, a diagram view of the first embodiment of the present invention is illustrated. The cap (mask) (6) can be taken apart from the seat (1) and place upside down beside the seat (1). The inverted claw-like top border of the cap (mask) (6) is shaped as a pedestal (61) to place on the desktop evenly. As the unpeeled fruit (8) presses downward onto the cutting edge (51) of the reamer (5), the reamer (5) penetrates into the unpeeled fruit (8), the core portion of the unpeeled fruit (8) inlaid into the cutting edge (51), and the pulp of the fruit surrounded the outer circle of the reamer (5). Start of a motor makes the reamer (5) to rotate, rub against the pulp of the fruits, the extracted juice (81) first seeping down through the straining tray (4) and then dropping into the gathering tray (3), finally, dripping from an inclined dispel tube (32) to gather into the cap (mask) (6). The residue dregs (82) of pulp left over the straining tray (4) can be swept away by the swirling scraper (56) continuously to prevent the straining slits (42) from blocking off and let the juice seep through the gathering tray (3) easily.

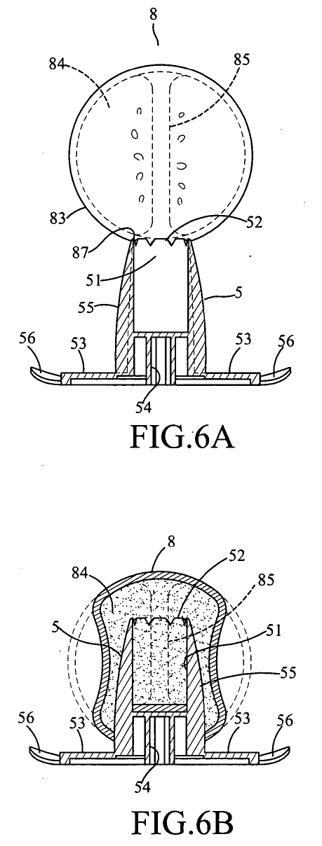

Referring to FIG. 5, a whole cross section view of the juicer is illustrated. Also please refer to FIG. 6, a whole cross section view of the reamer is illustrated. Said reamer (5) is made of plastics. The reamer (5) has a truncated apex opening cutting edge (51) which is formed as a central lower sealed bottom circumscribed and defined by an upper opening. Thus a depth formed within the cutting edge (51) as desired. Said cutting edge (51) being further provided with a plurality of annularly arranged teeth (52) along the top border of the cutting edge (51), the ridges of the teeth (52) are sharp. The round circumference of the reamer 5 is radially arranged with a plurality of vertical claw shaped projections (55). The vertical projections are easy to squeeze and press the pulp. Furthermore, the bottom of the reamer (5) integrally formed a base member (53) like an inlaid-disk make the structure of the reamer (5) more stable. And the rim of the base member (53) bulged out to form lateral scrapers (56). The scrapers (56) are floated close to the straining tray (4) to sweep away the residue dregs (82) of pulp. Said lower sealed bottom of the cutting edge has a polygonal locking receptacle (54) formed downwardly on its underside for securing an upstanding waterproof nut (2) mounted on a driving unit of said juicer. The straining tray (3) is located above the gathering tray (4), and they are combined to form a double-deck container without a movement, but the reamer (5) can be swiveled above the filter tray (4).

The user places the unpeeled fruits (8) such as the navel of the orange, Sunkist or citrus on the top end of the reamer (5), and then presses downward the unpeeled fruits (8) upon the reamer (5), the cutting edge (51) of the reamer (5) first penetrates through the peel and then into the pulp, the reamer (5) is endured increased pressure exerted by the user's palm. Under loading condition, the occupant weight sensor conducts a start of the driving device (11), further make the driving shaft (12) and waterproof nut (2) to rotate, and simultaneously make the reamer (5) to rotate. Owing to the user still presses downward onto the reamer, the reamer (5) will be swiveled continuously and penetrates deep into the unpeeled fruits (8). The rotational claw shaped projections surface (55) are in a tight squeeze upon the pulp to extract and seep the juice continually. The seeping juice may drop downward through the straining tray (4), being accumulated into the gathering tray (3), and then dips along the dispel tube (32). But the residue dregs of pulp left over the straining tray (4), the scrapers (56) projected up under the reamer 5 can scrape and sweep away the debris left over the straining tray (4) to protect the straining slits (42) from blocking off.

Referring to FIGS. 6A˜6B, after the reamer (5) penetrates deep into the unpeeled fruits (8), the core portion (85) of the unpeeled fruits is cut out by the cutting edge (51). But the core portion is the dry portion separated from the fruit with bitter tastes. So the cut out core portion will not reduce the amount of produce by extracting and squeezing from the pulp. Further while extracting the juice, the core portion of the fruit will be cut open an incisure (87) circular in shape. The circular incisure (87) leads to the saturated fibers along the pulp to be stripped and clipped off after the penetration of the reamer (5). Thus the unpeeled fruit presses downward to cut out the core portion (85) into the cutting edge (51) of the reamer (5). Even the squeezed fruit (8) is drawn out from the reamer (5); the core portion will be accompanied with the squeezed fruit to be drawn out from the reamer (5). Because the top end of the core portion (85) still gets fiber link with the peel (83), so the user can draw out the fruit (8) with the core portion (85) together from the reamer (5) simultaneously. The core portion (85) will not be retained in the reamer (5). The present invention can squeeze the unpeeled fruit without pre-processing as cut-halves, after the extraction of juice, the whole unpeeled fruit can be drawn out from the reamer to throw out. The procedure of the operation is merely easy one-step to complete the extraction work.

### The Second Embodiment

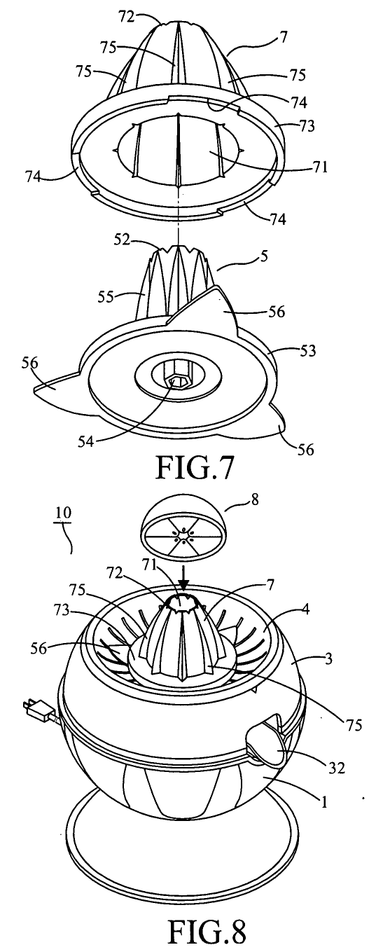

Referring to FIG. 7, a diagram view of the combined double deck reamer is illustrated. A mask (7) fit over the reamer (5) is disclosed in the FIG. 7. The mask (7) is, a half-ellipsoid shaped, larger than the reamer (5). The top portion of the cone shaped mask (7) may be an apex, or as shown in the FIG. 7, having a truncated apex opening cutting edge (71). The lower end of the cutting edge (71) is not shaped as a sealed bottom, which is different from cutting edge (51) of the reamer (5) described in the first embodiment of the present invention. A sharp cutting edge (71) for engaging a fruit, said cutting edge (71) being further provided with a plurality of annularly arranged teeth (72). The round circumference of the mask (7) is radially arranged with a plurality of vertical claw shaped projections 75, the vertical claw shaped projections are easy to rub against the pulp, the bottom end of the mask (7) is base member (73) shaped like an inlaid-disk surrounded by the flanged rim of the mask (7) an annular tough (74) with apertures. The annular tough (74) is corresponding to and adapted to the scrapers (56) of the reamer (5). While being rotated the reamer (5), the annualr tough (74) is swiveled simultaneously.

Referring to FIG. 8, is a diagram view of the present invention applied to the half-automatic juicer. Cut-halves (8) are pressed onto the mask (7). The core portion will be cut out into the cutting edge (71) of the mask (7). But the round circumference of the mask (7) surrounded by the pulp, which is rubbed against by the vertical claw shaped projections (75) to seep out juice. The enlarged cap of the mask (7) is applied to squeezing the juice directly from the pulp onto the reamer by pressing user's palm downward only.

### The Third Embodiment

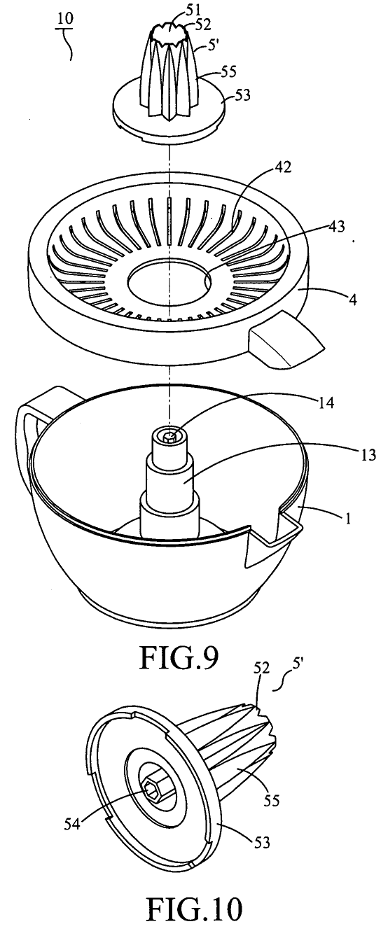

Referring to FIG. 9 is an exploded perspective view of the hand-operated juicer without motor driven depicted the structure of the hand-operated juicer includes a seat (1), a straining tray (4) located above the seat (1), a reamer (5) mounted onto the straining tray (4), mentioned above components are combined to form a reamer (5), (Please referring to FIG. 10) the reamer (5) is a bell-shaped tube with a truncated apex opening and a base member, which flares slightly downward and broad at the lower end. Said reamer (5) having a sharp cutting edge (51) for engaging a fruit, said cutting edge (51) being further provided with a plurality of annularly arranged teeth (52); and a base member integrally form on a lower portion of said reamer (5), said base member having a polygonal locking receptacle (54) for securing an positioning spindle (14) extended from a central pole (13) inside the seat (1). The reamer (5) is combined with the seat (1) to form a juicer without movements. Said reamer (5) is non-rotational thus omits the swivel scrapers (56) of the first embodiment. Said reamer (5) looks like the mask (7) of the second embodiment without the polygonal locking receptacle 54.

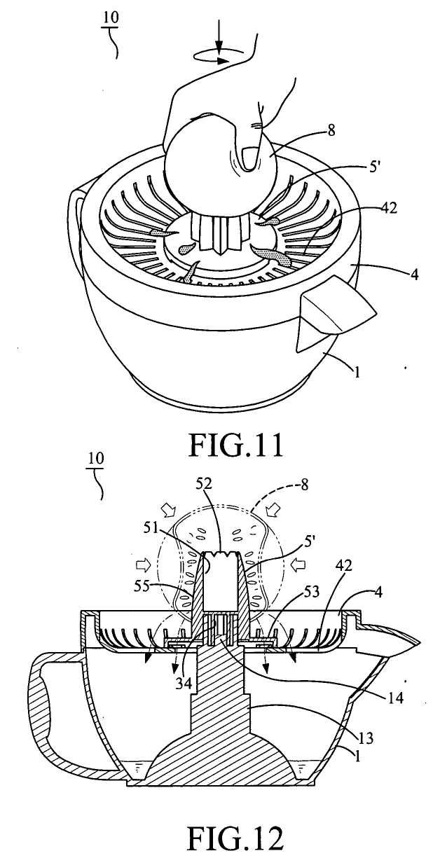

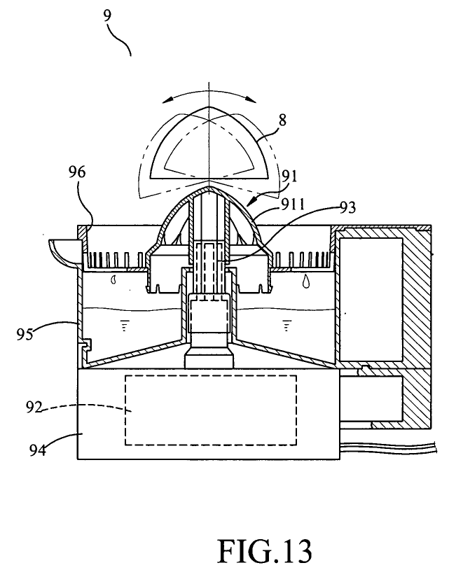

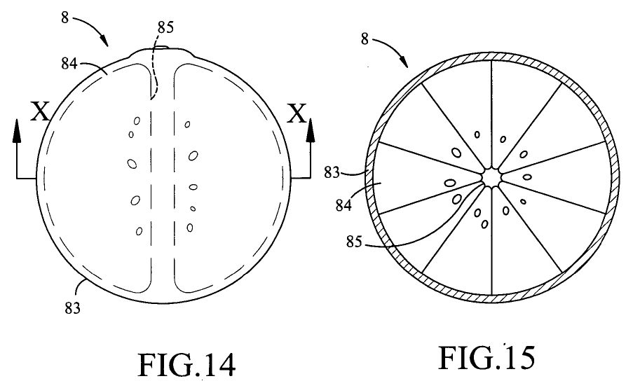

Referring to FIG. 11 and FIG. 12, a diagram view for squeezing juice and a whole cross section view of the third embodiment are illustrated. The action of squeezing juice is the same as the aforesaid first embodiment. The difference between them is not only the seat (1) without motor driven, but also the reamer without movements in the third embodiment. And the seat (1) can be applied to accumulate the juice as a container.

Furthermore, the third embodiment can be performed as a double deck structure of the reamer referring to same principle of the second embodiment.

1. A reamer structure of a juicer comprising:
a reamer is a bell-shaped tube with a truncated apex (51) and a base member (53); the reamer (5) has an opening (51) formed on the truncated apex (51) and a plurality of claw shaped projections (55) extended downward from said opening (51) and distributed radially along central axis of said reamer (5); said reamer (5) having a sharp cutting edge (51) for engaging a fruit, said cutting edge (51) being further provided with a plurality of annularly arranged teeth (52); and
a base member (53) integrally formed the bottom end of said reamer (5), said base member (53) having a polygonal locking receptacle (54) projected centrally downward inside its bottom thereby secured to an upstanding spindle extended from a driving unit of said juicer (10); scrapers (56) bulged out from along the flanged rim of the base member (53);
wherein a mask (7) fits over the reamer (5); said mask (7) having an annular through for adapting to the scrapers (56) bulged from the base member (53) of the reamer (5); said mask (7) has a plurality of claw shaped projections (75) extended downward from the truncated top opening (71).

2. A reamer structure of a juicer as claim 1 claimed, wherein said cutting edge further provided with a plurality of annularly arranged teeth.
